(19) United States
(12) Patent Application Publication
(10) Pub. No.: US 2013/0022313 A1
(43) Pub. Date: Jan. 24, 2013

(54) Optical Devices and Methods of Making and Using the Same

(71) Applicants: Hung-Yuan CHEN, Chengdu (TW); E-Min CHOU, Chengdu (TW); Chin-Hao FU, Chengdu (TW); Chih-Lung NIEN, Chengdu (TW)

(72) Inventors: Hung-Yuan CHEN, Chengdu (TW); E-Min CHOU, Chengdu (TW); Chin-Hao FU, Chengdu (TW); Chih-Lung NIEN, Chengdu (TW)

(21) Appl. No.: 13/339,874

(22) Filed: Dec. 29, 2011

(30) Foreign Application Priority Data
Jul. 21, 2011 (CN) 201110205181.8

(51) Int. Cl. G02B 6/26; B29C 65/00

(52) U.S. Cl. 385/31; 156/60

(57) ABSTRACT

A bi-directional fiber optical subassembly, including a laser diode, a photodiode and an optical fiber, an optical transceiver including the same, and methods of making and using the same are provided. An antireflection unit is added to a position facing the photodiode within the transceiver. The antireflection unit is configured to decrease or eliminate reflected light interference within the transceiver. The present subassembly, transceiver, and methods can reduce, minimize, or prevent interference, and the performance of the optical subassembly can also be enhanced by decreasing or eliminating reflected light interference within the transceiver.

### CROSS REFERENCE TO RELATED APPLICATION

This application claims the benefit of Chinese Patent Application No. 201110205181.8, which was filed on Jul. 21, 2011, and is hereby incorporated by reference as if fully set forth herein.

### FIELD OF THE INVENTION

The present invention generally relates to the field of optical communication, in particular to an optical subassembly (e.g., a bi-directional fiber optical subassembly in an optical transceiver) capable of reducing interference from internally reflected light.

### DISCUSSION OF THE BACKGROUND

In general, conventional communication may be enabled via network media such as optical fiber or twisted-pair cable. Specifically, communication via optical fiber is useful for long-distance transmission, providing low distortion and anti-disturbance capabilities, while communication via twisted-pair cable may provide simple accessing and good compatibility with other communication apparatuses and devices. An optical fiber transceiver provided with the two above-mentioned modes of communication can convert either of the two modes to the other.

An optical transceiver is a key subassembly for an optical fiber transceiver, and the optical transceiver is generally configured to enable inter-conversion between light and electricity. Therefore, the performance of the optical transceiver can have a direct impact on the performance of the whole transceiver, and can determine or influence performance parameters of the transceiver such as communication distance, signal rate, and/or error rate, etc.

A conventional bi-directional optical fiber subassembly 100 is shown in FIG. 1. In the conventional bi-directional optical fiber transceiver 100, a wave separator 130 oriented at a 45-degree angle is mounted between a laser diode 110 and an optical fiber 140. The laser diode 110 converts electronic signals into an optical signal, which is provided to the optical fiber 140 via the wave separator 130. An input optical signal from the fiber 140 is reflected by the wave separator 130, and then is received along the input optical path by a photodiode 120, which is configured to convert the optical signal into electronic signal for transmission. In operation, optical path interference caused by an internal reflection (represented by the thick lines 150a-b in FIG. 1) in the subassembly and the reflection (represented by the dashed lines 160a-b in FIG. 1) from the end face of the optical fiber 140 results in a reduction in the performance of the bi-directional fiber optical subassembly 100.

This “Background” section is provided for background information only. The statements in this “Background” are not an admission that the subject matter disclosed in this “Background” section constitutes prior art to the present disclosure, and no part of this “Background” section may be used as an admission that any part of this application, including this “Background” section, constitutes prior art to the present disclosure.

### SUMMARY OF THE INVENTION

Embodiments of the present invention relate to methods and apparatuses for reducing optical path interference caused by one or more internal reflections in a conventional optical transceiver subassembly. In one aspect, the invention concerns an optical device (e.g., a bi-directional fiber optical assembly, an optical subassembly, a transceiver, transmitter or receiver, etc.), comprising a subassembly including a laser diode, a photodiode, and an optical fiber. The subassembly also comprises an antireflection unit facing the photodiode. The antireflection unit is configured to decrease or eliminate reflected light interference within the device. According to one embodiment, the optical assembly has an internal wave separator oriented at a 45-degree angle with respect to the laser diode and the optical fiber. In various embodiments, the antireflection unit can comprise an opening, a reflector or an optical absorber. According to the embodiment where the antireflection unit comprises a reflector, an intersection angle β between the reflector and the axis of the photodiode should be greater than the angle generated by divergence or convergence of the laser beam. The present devices are suitable for use in an optical receiver or transceiver assembly or device, such as a receiver optical subassembly (ROSA), a bi-directional optical subassembly (BOSA), an optical transceiver, etc.

In a second aspect, a method of manufacturing an optical device generally comprises (i) affixing or securing a laser diode, a photodiode, and an optical fiber within a housing of the optical device or into an opening in the housing of the optical device, and (ii) forming or affixing an antireflection unit in or to the housing of the optical device so that the antireflection unit faces the photodiode. In exemplary embodiments, the antireflection unit is configured to decrease or eliminate reflected light interference within the optical device. The method may also comprise forming or affixing an internal wave separator in the optical device, wherein the internal wave separator is positioned at about a 45° angle with respect to the laser diode and the fiber. Further embodiments may comprise securing or affixing one or more mirrors, filters, and/or lenses within the housing of the optical device.

A third aspect of the present invention concerns a method of processing an optical signal in an optical transceiver (for example, in the optical device), comprising (i) receiving an electrical signal, (ii) converting the electrical signal to an output optical signal using the laser diode, (iii) transmitting the output optical signal to an optical fiber through an internal wave separator, and (iv) reducing or minimizing internal light reflected by the internal wave separator from reaching the photodiode using an antireflection unit. In exemplary embodiments, the antireflection unit is configured to decrease or eliminate reflected light interference within a transceiver subassembly.

Various embodiments of the present invention can advantageously reduce, minimize or prevent interference by internally reflected light, and the performance of the optical subassembly and transceiver including the same can also be enhanced by decreasing or eliminating reflected light interference within the transceiver. These and other advantages of the present invention will become readily apparent from the following description of various embodiments.

### BRIEF DESCRIPTION OF THE DRAWINGS

The present invention will become readily apparent from the detailed description of various embodiments and drawings below, in which:

FIG. 1 is a diagram illustrating a conventional optical transceiver.

FIG. 2 is a diagram showing a first exemplary optical device in accordance with the present invention.

FIG. 3 is a diagram showing a second exemplary optical device in accordance with the present invention.

FIG. 4 is a flowchart showing an exemplary method of processing an optical signal in accordance with the present invention.

FIG. 5 is a flowchart showing an exemplary method of making an optical device in accordance with the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

Except for mutually exclusive features and/or steps, all the features or steps of all the methods or procedures disclosed in this specification can be recombined in any manner. Any feature including those disclosed in any claim, the Abstract and the Figures herein, can be replaced by other equivalent or features with similar function(s), purpose(s) and/or objective(s), unless distinctly described to the contrary. Each feature described herein may be viewed as one example of a series of equivalent or similar features.

For the sake of convenience and simplicity, the terms “optical” and “optoelectronic” are generally used interchangeably herein, and use of any one of these terms also includes the others, unless the context clearly indicates otherwise. Additionally, the terms “optical device,” “optoelectronic device,” and “optical transmitter” are generally used interchangeably herein, and use of any one of these terms also includes the others, unless the context clearly indicates otherwise. Similarly, the terms “optical signal” and “light” are generally used interchangeably herein, and use of any one of these terms also includes the others, unless the context clearly indicates otherwise. In addition, the terms “optical path,” “optical light path,” and “optical signal path,” are generally used interchangeably herein, and use of any one of these terms also includes the others, unless the context clearly indicates otherwise. Also, for convenience and simplicity, the terms “connected to,” “coupled with,” “coupled to,” and “in communication with” (which terms also refer to direct and/or indirect relationships between the connected, coupled and/or communicating elements unless the context of the term's use unambiguously indicates otherwise) may be used interchangeably, but these terms are also generally given their art-recognized meanings

The invention, in its various aspects, will be explained in greater detail below with respect to exemplary embodiments.

In order to avoid optical path interference caused by internal reflection(s) by the assembly housing and the reflection from the end face of the optical fiber, the optical devices (e.g., bi-directional transceiver subassemblies, etc.) of the present invention prevent interference by decreasing or eliminating internal reflections within the device or (sub)assembly.

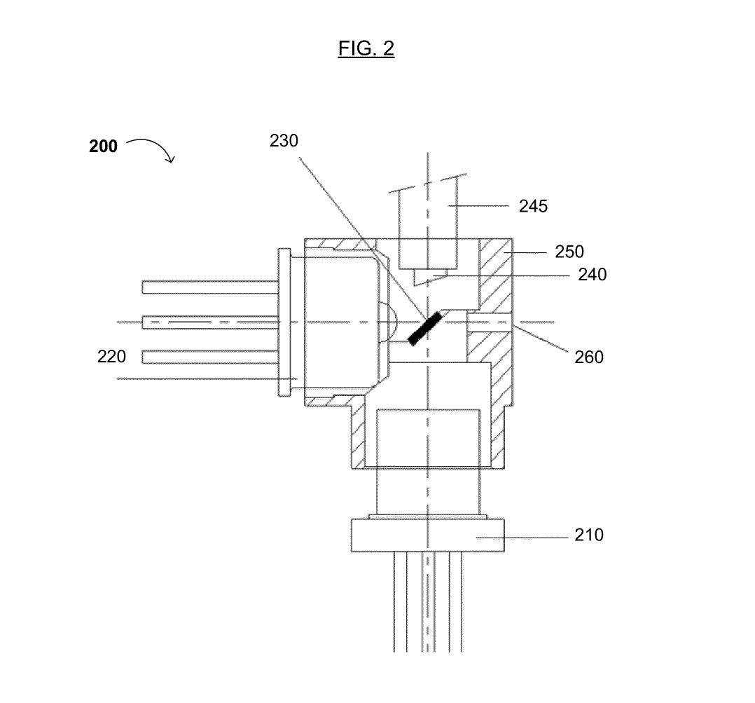

FIG. 2 illustrates a first exemplary optical device 200 according to the present invention. Optical device 200 may be a bi-directional optical subassembly (e.g., within an optical transceiver) or any other device capable of transmitting, receiving and optionally processing an optical signal. Optical device 200 may comprise or be contained within a (metal) housing 250. Optical device 200 may further comprise laser diode 210, photodiode 220, and optical fiber 240. The device also has an internal wave separator 230 which is oriented at a 45-degree angle with respect to the laser diode 210 and fiber 240. The housing 250 may have an opening through which the laser diode 210 is placed. The laser diode 210 is generally configured to receive an electronic signal and convert the electric current into an optical signal. For example, the optical device 200 is generally configured to receive electrical signals (e.g., from an external network component [not shown]), and provide an optical signal from the laser diode 210. Electrical circuitry (not shown) provides the electrical signals to the laser diode 210 (e.g., by converting and/or modulating the received electrical signals) in a form that the laser diode 210 can output as an optical signal.

The housing 250 may also have an opening in which a light-carrying or light transmitting medium 240 is placed. The light-transmitting medium 240 may comprise a fiber optic cable or other optical fiber, which may be surrounded (or sheathed) by a ceramic material 245. In some embodiments, and as shown in FIG. 2, a portion of the optical fiber 240 may be uncovered (or unsheathed) at an end closest to a light-receiving unit 220. Generally, the optical fiber 240 is configured to receive an optical signal from the laser diode 210. Typically, the optical signal is a diffuse light beam (e.g., slightly cone-shaped and/or having a characteristic enlargement or spreading of the beam size, width or diameter as a function of distance), but the invention is also applicable to other light beams or optical signals, such as polarized and/or collimated light beams or optical signals.

In some embodiments, the light-transmitting medium (e.g., optical fiber) 240 may be configured to simultaneously carry or transmit more than one signal. Furthermore, each signal may have a same or a different wavelength. For example, a first signal at a first wavelength or wavelength band may be received by the optical device 200, and a second signal at a second wavelength or wavelength band significantly different from the first wavelength or wavelength band may be transmitted by the optical device 200.

As shown in FIG. 2, the optical fiber 240 (or other light-transmitting medium) is positioned to face the laser diode 210 (e.g., at about a 180° angle). An internal wave separator 230 (e.g., a beam splitter) is positioned between the laser diode 210 and the optical fiber 240. The internal wave separator 230 is configured to reflect at least a portion of the light beam emitted from light-transmitting medium (optical fiber) 240. The internal wave separator 230 and the optical fiber 240 may be aligned such that the light beam transmitted by the optical fiber 240 is incident upon the internal wave separator 230. In one embodiment, the angle of incidence of the transmitted light beam upon the internal wave separator 230 may be about 45° (e.g., exactly) 45°. Consequently, the internal wave separator 230 leans toward the laser diode 210 and the optical fiber 240 at about a 45° angle.

In various embodiments, the internal wave separator 230 may comprise a dichroic mirror, a wavelength selective filter (made of or coated with a reflective material), a polarization component, an amplitude modulation mask, a phase modulation mask, a hologram, and/or a grating. In one embodiment, substantially all light transmitted from the optical fiber 245 to the internal wave separator 230 is reflected. In general, the internal wave separator 230 also allows a second beam from the laser diode 210 to pass through. The light which passes through the internal wave separator 230 generally comprises light of a second wavelength, where the second wavelength is different from the first wavelength. The first and second wavelengths may differ by a minimum of about 100-200 nm, generally up to about 500-1000 nm. Alternatively, the first and second wavelengths may differ by at least about 5, 10, 15 or 20%, up to as much as 25, 50 or 100%.

As shown in FIG. 2, the optical device includes a light-receiving unit 220. The light-receiving unit 220 may comprise a photodiode (e.g., a PIN photodiode, etc.) or other light-detecting component(s), and in some embodiments, may include an amplifier (e.g., a transimpedence amplifier and/or a limiting amplifier). The light-receiving unit (photodiode) 220 is positioned at a side of the light-transmitting medium 240 (fiber optic cable or other optical fiber, etc.) and the laser diode 210. In exemplary embodiments, the photodiode 220 faces the internal wave separator 230. The photodiode 220 receives an input optical signal from the optical fiber 240 along an optical signal path after the optical signal reflects off the internal wave separator 230. In general, the photodiode 220 is configured to convert the input optical signal (e.g., to an electric signal) received from the optical fiber 240.

In exemplary embodiments, the optical subassembly 200 also includes an antireflection unit that is configured to decrease or eliminate reflected light interference (e.g., optical path interference cause by internal reflection) within the device or transceiver. In exemplary embodiments, the antireflection unit may be an opening, a reflector, an optical absorber, or any other device in the art suitable for reducing or eliminating internal reflection within the device housing. For example, in the embodiment of FIG. 2, the antireflection unit comprises an opening 260 in the housing 250 of the device 200. The opening 260 is generally in a position in the housing 250 that faces the photodiode 220 so that light exits the device 200 and is not reflected internally. In various embodiments, the opening 260 has dimensions (e.g., a diameter or a height and width) greater than the spot size of the reflected light signal, and in some cases, greater than the spot size of the reflected light signal by 2 times, 3 times, 5 times, or more. Alternatively, the opening 260 has dimensions of about 25-75% of those of the wave separator 230. In one embodiment, the opening may be filled with a transparent and/or antireflective material, such as quartz, a silicate glass, a polyethylene, polypropylene, polyurethane or polycarbonate material, another transparent or anti-reflective ceramic or plastic material, etc. In exemplary embodiments, the opening 260 is positioned in the housing 250 such that an output parameter (e.g., the maximum output power or current) of the optical device 200 is maximized or optimized. The opening 260 is configured to prevent interference within the subassembly. Consequently, the performance of the optical device (e.g., bi-directional fiber optical subassembly, transceiver, etc.) is enhanced as reflected light interference (e.g., internal reflection) within the device is decreased or eliminated.

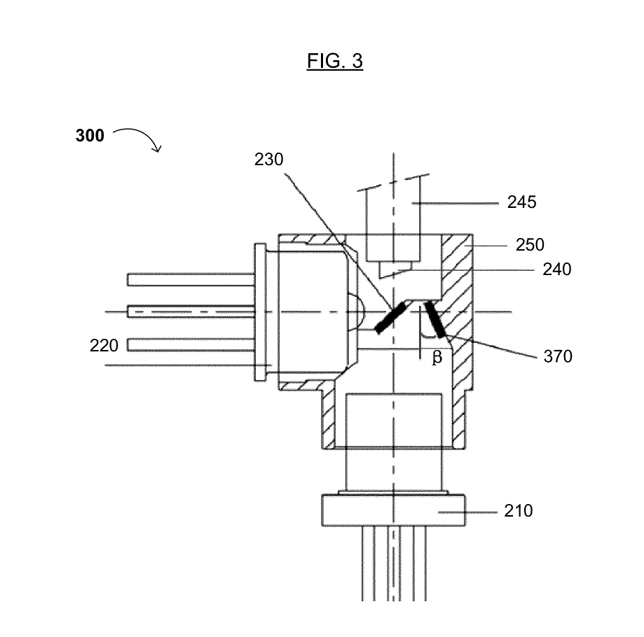

FIG. 3 illustrates a second exemplary optical device or (sub)assembly 300 according to the present invention. As shown, the optical device 300 comprises structures similar to those of optical device 200 of FIG. 2, wherein structures having the same identification numbers discussed below with respect to FIG. 3 may be substantially the same as those discussed herein with respect to FIG. 2. For example, the optical device or (sub)assembly 300 of FIG. 3 includes a laser diode 210, a light-transmitting unit 240 (e.g., an optical fiber, etc.), and a light-receiving unit 220 (e.g., a photodiode), each of which is positioned within a housing 250. The optical device 300 also includes an internal wave separator 230, which is oriented toward the laser diode 210 and optical fiber 240 at a 45° angle, as previously described herein with regard to FIG. 2.

In the embodiment shown in FIG. 3, the antireflection unit comprises a reflector 370 affixed within the optical device 300 or to the housing 250, and positioned to face the photodiode 220. In exemplary embodiments, the reflector 370 is positioned so that an intersection angle β between the reflector 370 and an axis from the photodiode 220 is greater than an angle generated by a converging or a diverging laser beam. When reflector 370 is in a position facing the photodiode 220, as shown in FIG. 3, interference can be prevented and the performance of the optical device (e.g., transceiver) can be enhanced via changing the direction of reflection within the optical device 300. In some embodiments, the antireflection unit (e.g., reflector 370 of FIG. 3) is generally positioned in the housing 250 such that an output parameter (e.g., the maximum output power or current) of the optical device 300 is maximized or optimized.

Although not shown in the embodiments of FIGS. 2 and 3, in some alternative embodiments, an optical absorber or any other device capable of preventing internal reflected light and interference can be placed in the optical device 200/300 or on an internal surface of the housing 250 in a position facing the photodiode 220. Also not shown in the figures, in some embodiments, the optical device 200/300 may further comprise one or more mirrors, lenses, and or filters.

For example, the optical device may further include one or more lenses (e.g., a half-ball lens, a concave lens, a convex lens, or a combination of concave and convex lenses, etc.) configured to provide a focused and/or collimated light signal to the one or more mirrors. If desired, the optical signal may pass through a filter (e.g., a bandpass filter) prior to reaching the light-receiving unit (photodiode) 220. In such embodiments, the filter is generally configured to narrow or reduce a wavelength band of the optical signal, and provide a filtered optical signal to the photodiode. The filter can be placed at any suitable location along the optical path (e.g., between the internal wave separator and the one or more mirrors, between the mirrors and lenses, etc.).

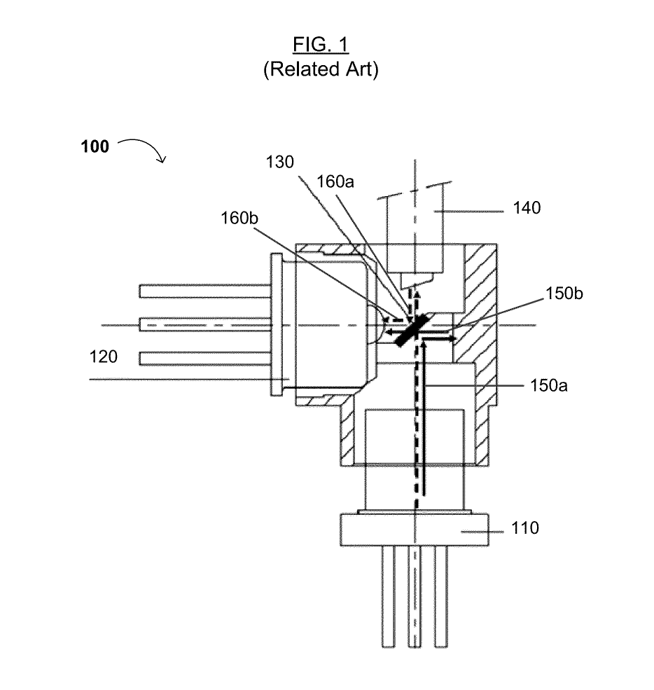

By utilizing an antireflection unit (e.g., e.g., opening 260 of FIG. 2, reflector 370 of FIG. 3, an optical absorber, etc.), optical path interference (e.g., reflected light interference) caused by internal reflection in optical transceivers can be decreased or prevented, and the performance of the optical transceiver can be improved relative to the conventional configuration of FIG. 1.

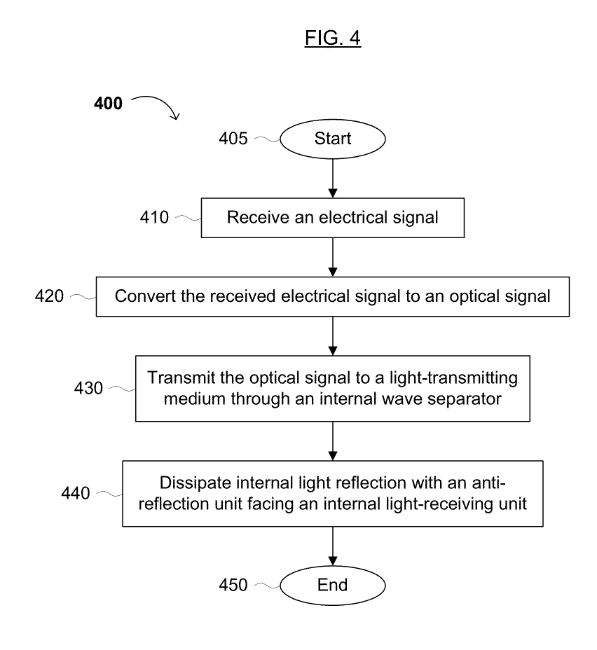

FIG. 4 shows a flowchart 400 illustrating an exemplary method for processing an optical signal. As shown, at 405 the method begins, and at 410, an electrical signal is received (e.g., in the optical transceiver/subassembly 200 in FIG. 2). In some embodiments, at 410, an electrical output signal is received at a laser diode (reference character 210 of FIG. 2), which then converts the electrical output signal into an optical signal at 420.

As shown in FIG. 4, at 430, the exemplary method further comprises transmitting the optical signal to a light-transmitting medium, such as optical fiber 240 of FIG. 2, through an internal wave separator (e.g., a dichroic mirror, filter, beam splitter, etc.). Referring again to FIG. 4, at 440, the method comprises dissipating any light reflected by the internal wave separator inside the housing of the optical transceiver using an antireflection unit positioned to face an internal light-receiving unit in the optical transceiver. The antireflection unit may comprise an opening (e.g., 260 of FIG. 2), a reflector (e.g., 370 of FIG. 3), an optical absorber, a transparent or anti-reflective material, or any other device known in the art capable of reducing or preventing internal light reflectance. Dissipating such light reduces or minimizes internal light reflections towards the light-receiving unit (e.g., photodiode 220 of FIG. 2).

Although not shown in FIG. 4, the method may also comprise converting a received optical signal to an input electrical signal by the light-receiving unit (e.g., photodiode). In addition, although not shown in FIG. 4, the method may also comprise (1) reflecting the received optical signal off the internal wave separator, positioned at a 45° angle with respect to the, wherein the one or more mirrors are configured to reduce or minimize the sensitivity of the received optical signal to polarization, (2) passing the output optical signal and/or the received optical signal through one or more lenses configured to provide a focused and/or collimated optical signal, and/or (3) passing the output optical signal and/or the received optical signal through a filter configured to reduce or narrow a wavelength band of the optical signal. At 450, the method ends.

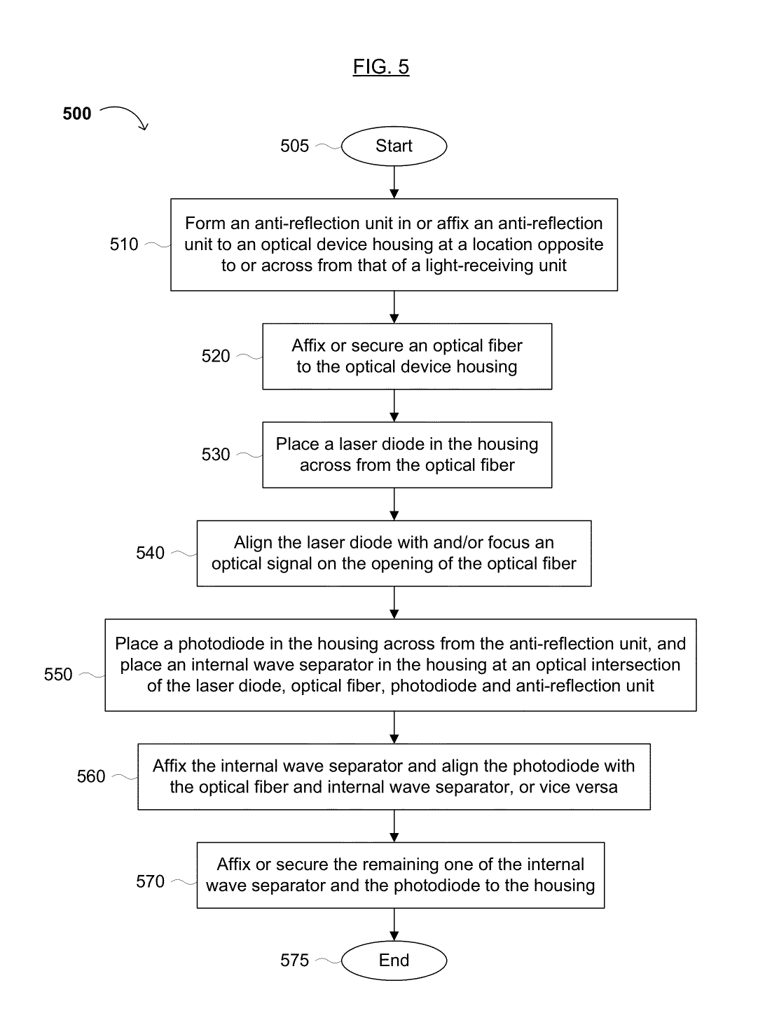

Referring now to FIG. 5, flowchart 500 illustrates an exemplary method of manufacturing an optical device according to the present invention. At 505, the method begins, and at 510, an antireflection unit as described herein is formed in or on, or affixed to, the housing of the optical device. In general, the antireflection unit is positioned at a location in the housing configured to decrease or eliminate reflected light interference in the optical device. For example, referring to FIG. 2, in one embodiment, the method comprises forming an opening 260 in the housing 250 opposite to and/or facing the location of a light-receiving unit (e.g., photodiode 220). The opening 260 in the housing 250 is formed in a position to allow light reflected by the internal wave separator to exit the optical device 200. Consequently, reflected light interference within the optical device (and/or optical transceiver [sub]assembly) is decreased or eliminated. In some embodiments, the opening 260 may be formed mechanically using a punch, drill, molding or other suitable device known in the art. In a further alternative, the opening 260 may be filled with a transparent or anti-reflective material, which may provide a mechanical barrier to ingress of dirt, dust, moisture or other contaminant into the housing, while still decreasing, preventing or eliminating interference by light reflected within the housing and/or optical transceiver (sub)assembly.

Referring again to FIG. 5, at 510, in some embodiments, forming or affixing the antireflection unit comprises affixing a reflector or an optical absorber within the housing at a location that faces the location of the light-receiving unit (e.g., photodiode). When the antireflection unit comprises a reflector, it is placed so that an intersection angle (e.g., β in FIG. 3) between the reflector and the axis of the photodiode is greater than an angle generated by a converging or diverging laser beam. The reflector or optical absorber may be secured or affixed by applying a binding substance (e.g., a glue or adhesive) to one or more surfaces of the reflector/absorber, and attaching the reflector or optical absorber to the housing. In other embodiments, the glue or adhesive may be applied to the optical device housing and/or to a mount for positioning the reflector/absorber in the housing.

Next, the exemplary method generally comprises affixing the optical device components (e.g., laser diode, photodiode, optical fiber and internal wave separator) to the housing. In such embodiments, the components can be attached to the optical device housing using one or more adhesives or other binding substances, or any other suitable attachment mechanism known in the art. Referring now to FIG. 2, in the exemplary embodiment shown, the optical fiber 240 is affixed to the housing 250 so that it is facing the laser diode 210, and the photodiode 220 is affixed to the housing 250 so that it is facing the antireflection unit 260, in a perpendicular position to that of the optical fiber 240 and the laser diode 210. The internal wave separator 230 is generally placed at the optical intersection of the optical fiber 240, the laser diode 210, the photodiode 220 and the antireflection unit 260. Furthermore, the components can generally be placed, aligned and secured to the housing in any sequence or order, and the following description is but an exemplary process for doing so.

Referring back to FIG. 5, at 520, the optical fiber is affixed or secured to the housing by one or more conventional techniques. Then, at 530, the method comprises placing the laser diode (or a transmitter subassembly including the laser diode) in the housing of the optical device at a location across from the optical fiber. Thereafter, the laser diode may be aligned with an opening of the optical fiber, or a light beam output from the laser diode may be focused on the opening of the optical fiber at 540. When the alignment is complete (e.g., by determining that a maximum output power of the light beam is received in the optical fiber), the method comprises affixing or securing the laser diode to the housing (e.g., in the corresponding opening). For example, in some embodiments, affixing or securing comprise applying a binding substance (e.g., a glue, adhesive, etc.) to a transmitter subassembly including the laser diode and/or in an opening in the housing configured to receive the transmitter subassembly, placing the transmitter subassembly in the opening in the housing, aligning the optical signal or beam from the laser diode with the optical fiber, and sealing or securing the transmitter subassembly in the opening in the housing.

At 550, the method further comprises placing the light-receiving unit (e.g., a receiver subassembly including the photodiode) and internal wave separator (e.g., a beam splitter, dichroic mirror, wavelength-selective filter, etc.) in the housing. The light-receiving unit or receiver subassembly may be placed in an opening in the housing configured to receive the light-receiving unit or receiver subassembly, and the internal wave separator is placed at an optical intersection of the optical fiber, the laser diode, the photodiode, and the antireflection unit (e.g., at an intersection of the axes defined by the optical path from the laser diode to the optical fiber and the optical path from the antireflection unit to the photodiode). The method may comprise applying a binding substance (e.g., a glue, adhesive, etc.) to (i) the light-receiving unit or receiver assembly, (ii) the internal wave separator, and/or (iii) the housing (e.g., the opening in the housing and/or the mount or other surface of the housing on or to which the internal wave separator is attached) prior to placing the light-receiving unit and internal wave separator therein.

In general, the internal wave separator is configured to reflect an input optical signal from the optical fiber to the photodiode. In exemplary embodiments, the internal wave separator is placed and aligned so that the angle of incidence of the received light beam from the optical fiber upon the internal wave separator is about (or is) 45°, and the internal wave separator is then affixed to the housing. Thereafter, the photodiode (or receiver subassembly comprising the photodiode) is placed in the corresponding opening in the housing and aligned with the received optical signal (or beam) reflected by the internal wave separator, then at 560, the photodiode or receiver subassembly is sealed or secured in the opening in the housing. Alternatively, the photodiode or receiver subassembly can be affixed or secured in the housing opening, then the internal wave separator positioned and aligned so that the reflected optical signal (or beam) is received in the photodiode at a maximum power. At 570, the remaining one of the photodiode or receiver subassembly and the internal wave separator is sealed or secured to the housing. The method ends at 575.

Although not shown in FIG. 5, the method may also comprise affixing, placing and/or attaching one or more lenses in the optical device to provide a focused and/or collimated light signal to one or more of the components of the optical device. In some embodiments, the method may include attaching or placing a filter at a location along an optical signal path in the optical device to narrow or reduce a wavelength band of the optical sign and provide a filtered optical signal (e.g., to the photodiode or to the optical fiber).

### CONCLUSION/SUMMARY

Thus, the present invention provides methods and apparatuses for reducing or eliminating interference by reflected light within an optical transceiver, thereby enhancing the performance of the optical transceiver or a subassembly thereof. The foregoing descriptions of specific embodiments of the present invention have been presented for purposes of illustration and description. They are not intended to limit the present invention (e.g., to the precise forms disclosed) or to be exhaustive, and obviously many modifications and variations are possible in light of the above teaching. The present invention can be expanded to any new features or any new combination thereof, and to any procedure or new method or procedure or any new combination thereof, disclosed in the present specification or otherwise. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. An optical device, comprising:
a) a subassembly comprising a laser diode, a photodiode, and an optical fiber; and
b) an antireflection unit facing the photodiode, wherein the antireflection unit is configured to decrease or eliminate reflected light interference within the optical device.

2. The optical device of claim 1, wherein the optical device comprises a bi-directional fiber optical assembly.

3. The optical device of claim 1, further comprising an internal wave separator configured to (i) transmit an output optical signal from the laser diode to the optical fiber and (ii) reflect a received optical signal from the optical fiber to the photodiode.

4. The optical device of claim 3, wherein the internal wave separator is positioned such that the received optical signal has an angle of incidence of about 45°.

5. The optical device of claim 3, further comprising a housing configured to house the laser diode, the photodiode, the optical fiber, the antireflection unit, and the internal waver separator.

6. The optical device of claim 5, wherein the laser diode and the optical fiber define a first optical axis, the photodiode and the antireflection unit define a second optical axis, and the internal waver separator is at an intersection of the first and second axes.

7. The optical device of claim 1, wherein the antireflection unit comprises an opening.

8. The optical device of claim 1, wherein the antireflection unit comprises a reflector.

9. The optical device of claim 8, wherein an intersection angle between the reflector and an axis of the photodiode is greater than an angle of a converging or diverging laser beam.

10. The optical device of claim 1, wherein the reflector comprises an optical absorber.

11. A method of processing an optical signal in an optical transceiver, comprising:
a) receiving an electrical output signal;
b) converting the electrical output signal to the optical signal using a laser diode of the optical transceiver;
c) transmitting the optical signal to an optical fiber through an internal wave separator of the optical transceiver; and
d) reducing or minimizing internal light reflected by the internal wave separator from reaching a photodiode of the optical transceiver using an antireflection unit.

12. The method of claim 11, wherein the antireflection unit comprises an opening, a reflector, or an optical absorber.

13. The method of processing an optical signal of claim 11, wherein the antireflection unit, the internal wave separator and the photodiode are on a same optical path.

14. A method of manufacturing an optical device, comprising:
a) forming or affixing an antireflection unit in or to a housing of the optical device in a location facing a photodiode of the optical device, wherein the antireflection unit is configured to decrease or eliminate interference from light reflected within the optical device; and
b) affixing or securing a laser diode, the photodiode, and an optical fiber in or to the housing.

15. The method of claim 14, comprising forming the antireflection unit by mechanically forming an opening in the housing, and optionally, filling the opening with a transparent and/or anti-reflective material.

16. The method of claim 14, wherein forming or affixing the antireflection unit comprises affixing a reflector or an optical absorber in or on the housing.

17. The method of claim 16, wherein the antireflection unit comprises the reflector, and affixing the reflector comprises placing the reflector so that an intersection angle between the reflector and an axis of the photodiode is greater than an angle generated by a converging or diverging laser beam.

18. The method of claim 14, further comprising affixing or securing an internal wave separator in the housing, wherein the internal wave separator is configured to (i) transmit an output optical signal from the laser diode to the optical fiber and (ii) reflect a received optical signal from the optical fiber to the photodiode.

19. The method of claim 18, comprising aligning either the photodiode or the internal wave separator with received light from the optical fiber.

20. The method of manufacturing an optical device of claim 19, wherein the received light has an angle of incidence on the internal wave separator of about 45°.
